(19) United States
(12) Patent Application Publication
(10) Pub. No.: US 2025/0265102 A1
(43) Pub. Date: Aug. 21, 2025

(54) SYSTEM AND METHOD FOR PROGRESSIVE USER AUTHENTICATION IN A CONVERSATION INTERFACE

(71) Applicant: Celligence International LLC, Guaynabo, PR (US)

(72) Inventors: Pavan AGARWAL, Dorado, PR (US); Gabriel Albors Sanchez, San Juan, PR (US); Jonathan Ortiz Rivera, San Juan, PR (US)

(73) Assignee: Celligence International LLC, Guaynabo, PR (US)

(21) Appl. No.: 19/204,268

(22) Filed: May 9, 2025

Related U.S. Application Data
(63) Continuation of application No. 18/135,703, filed on Apr. 17, 2023.
(60) Provisional application No. 63/332,205, filed on Apr. 18, 2022.

(51) Int. Cl. G06F 9/451; G06F 40/174; G06F 40/205

(52) U.S. Cl. CPC G06F 9/453; G06F 40/174; G06F 40/205

(57) ABSTRACT

Systems and methods are disclosed for progressive user authentication integrated into a conversational interface. Rather than requiring up-front credential entry, the system passively captures identity signals—such as device metadata, geolocation, and conversational patterns—during natural language interaction with an automated assistant. A confidence score is computed in real time using a dynamic identity matrix. Based on the score and contextual risk assessment, the system selects an authentication path, including auto-authentication, low-friction verification, or fallback to biometric or knowledge-based challenges. Authentication decisions and outcomes are logged for compliance and security auditing.

### RELATED APPLICATIONS

This application a continuation of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD

The present disclosure relates generally to user authentication technologies. More particularly, the present disclosure relates to systems and methods for progressively authenticating users based on conversational interaction and dynamic analysis of user-provided data and contextual information.

### BACKGROUND

Traditional user authentication systems require upfront verification of identity, such as by presenting login credentials (e.g., username and password) before allowing access to system features or services. While this method provides a basic level of security, it interrupts the user experience by introducing friction at the outset of interaction. In many cases, users may only require access to non-sensitive information or low-risk services, making full authentication at the initial stage unnecessary. Additionally, the rigid nature of static authentication models limits opportunities for systems to adapt verification processes based on context, risk, or user behavior.

Recent advancements in conversational interfaces and artificial intelligence (AI) technologies have enabled systems to engage users in more natural, fluid interactions. These systems can capture user-provided data, device-specific metadata, and conversational patterns dynamically over the course of the interaction. Despite these technological advancements, existing authentication approaches have not fully capitalized on the opportunity to progressively and intelligently authenticate users based on conversational engagement and risk-adaptive criteria.

Accordingly, there is a need for systems and methods that enable progressive user authentication within conversational environments. Such systems would be capable of building and updating a dynamic identity profile in real time, evaluating confidence scores based on passively collected signals, and selecting appropriate authentication paths—ranging from seamless access to biometric fallback—based on contextual risk. These systems can improve both user experience and system security by reducing unnecessary friction while maintaining robust authentication control.

### SUMMARY

In various embodiments, the disclosed system provides a framework for progressive user authentication integrated into a natural language conversation interface. Unlike traditional systems that require up-front credential entry, the system builds a real-time identity profile based on passive signals captured during interaction, including device-specific metadata, geolocation, conversational phrasing, and historical behavior patterns.

A confidence score is computed dynamically from these signals using a modular architecture that includes an identity signal capture engine, a dynamic identity matrix builder, and a risk assessment and scoring module. Based on this confidence score and context-specific risk evaluation, the system selects an appropriate authentication path. Authentication may proceed without any explicit challenge (auto-authentication), through a low-friction method such as a one-time token, or via a more rigorous fallback mechanism such as biometric verification or knowledge-based questions.

The system is further configured to adaptively escalate authentication based on anomalies or sensitive request types, while also supporting multi-session continuity and optional human assistant (HA) escalation. All signals, authentication decisions, and outcomes are securely logged for traceability and compliance auditing. This approach improves both user experience and security by minimizing unnecessary friction, tailoring authentication to real-time context, and leveraging the full range of conversational signals during interaction.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram of an exemplary system architecture for progressive user authentication based on conversational interaction, according to an implementation of the disclosure.

FIG. 2 is a system-level diagram showing modular components for identity signal capture, identity matrix construction, risk scoring, authentication decisioning, and audit logging, according to an implementation of the disclosure.

FIG. 3 is a decision tree illustrating how the system dynamically selects authentication paths based on confidence scoring and risk evaluation, according to an implementation of the disclosure.

FIG. 4 illustrates an example computing system that may be used in implementing various features of embodiments of the disclosed technology.

Described herein are systems and methods for progressive user authentication integrated into a conversational interface. Rather than requiring upfront login credentials, the disclosed system captures identity-related signals dynamically during natural language interaction with an automated assistant (AA). These signals—such as device metadata, geolocation, and linguistic patterns—are used to construct a dynamic identity matrix and compute a real-time confidence score. Based on the confidence score and contextual risk evaluation, the system adaptively selects an appropriate authentication path, which may include seamless auto-authentication, low-friction challenges, or escalation to biometric or knowledge- based fallback methods. A human assistant (HA) may be optionally engaged in the event of failure or uncertainty. The architecture supports secure session continuity, modular decision logic, and robust audit logging. The following description sets forth several illustrative embodiments of the disclosed system, including modular architecture, messaging logic, and multi-device support. Other features and advantages will become apparent to those skilled in the art upon review of the specification, drawings, and claims. It is intended that all such systems, methods, features, and enhancements be considered within the scope of the present disclosure and protected by the accompanying claims.

### DETAILED DESCRIPTION

The disclosed system consists of a backend computing server and one or more client computing devices that facilitate progressive user authentication through conversational interaction. The system continuously collects, analyzes, and evaluates user-provided data, device metadata, and conversational patterns to build a dynamic identity profile, referred to herein as an identity matrix. Based on the evolving confidence level associated with the identity matrix, the system determines whether, when, and how to authenticate the user, selecting the simplest effective authentication method appropriate for the risk level and requested access.

Conventional systems for user authentication typically require upfront credential entry, such as username and password, before granting access to system features. These approaches introduce friction at the outset of interaction, discourage user engagement, and are often ill-suited for dynamic or conversational environments. Moreover, existing systems rely heavily on static credentials, which are vulnerable to theft and often fail to adapt authentication measures based on real-time context, device data, or behavioral cues.

Furthermore, conventional authentication frameworks do not leverage conversational interactions to progressively validate user identity. Systems that require repeated re-authentication or cannot differentiate between low-risk and high-risk requests burden the user unnecessarily and increase abandonment rates. No known systems dynamically adjust authentication requirements mid-conversation based on risk or confidence scoring derived from accumulated user behavior and contextual information.

The systems and methods disclosed herein produce several technical effects and advantages over conventional authentication approaches. These include enabling natural, low-friction user interactions that begin without immediate credential demands, dynamically building an identity profile during conversation, and adaptively triggering authentication challenges only when necessary, based on context-sensitive analysis.

Additional advantages include real-time confidence scoring of user identity based on passive and active signals, automated selection of optimal authentication methods (e.g., token, facial recognition, secret questions) according to risk level, and seamless progression through conversational workflows without disrupting user engagement. Unlike static authentication systems, the present system continuously refines the user's identity matrix, allowing for progressively stronger authentication without repeated interruption.

The system also maintains detailed audit logs of identity signals received, authentication triggers executed, and decision rationales, supporting transparency, compliance, and security audits. These techniques enable a highly adaptive, secure, and user-centric authentication process suited to modern conversational interfaces and multi-device environments.

The disclosed system includes several key components and modules, including but not limited to identity signal capture engine, dynamic identity matrix builder, risk assessment and scoring module, authentication decision engine, session manager, and audit logging module.

For example, and as will be described in greater detail below, the identity signal capture engine continuously collects metadata and conversational inputs, including device information (e.g., IP address, GPS location, device ID), user-provided data (e.g., stated name, email address, phone number), social media account information (where permitted), and behavioral patterns (e.g., typical phrasing, sentiment analysis). If permissioned, the system may also capture front-facing camera input or access registered device information for enhanced verification.

The dynamic identity matrix builder aggregates incoming signals over time, constructing a weighted profile of the user's likely identity. Early conversation stages may only support low-confidence identity assignments, while subsequent conversational depth increases confidence. Machine learning classifiers trained on past user behavior and known bad actor patterns may assist in strengthening or challenging the identity matrix.

The risk assessment and scoring module evaluates incoming user requests against the current state of the identity matrix. Requests that involve sensitive information or privileged access (e.g., financial status inquiries, document uploads) trigger re-evaluation of identity confidence. If the confidence score exceeds a threshold, access may be granted seamlessly. Otherwise, the authentication decision engine selects an appropriate challenge (e.g., password prompt, token delivery, facial recognition request) dynamically based on risk and session context.

The session manager tracks ongoing conversational sessions, updates the identity matrix over time, and ensures that authentication state persists across session pauses, resumptions, and device transitions. The audit logging module records all collected identity signals, confidence scores, authentication triggers, and user responses, supporting verifiability and compliance requirements.

The system initiates user interaction without immediate credential demands. Instead, identity signals are captured passively and actively as the conversation proceeds. For example, upon receiving an initial user message such as “Hi, this is Joe,” the system may record the stated name, extract device metadata, and begin analyzing speech patterns for identity markers.

Based on the type of request made during the conversation, the system dynamically assesses whether authentication is necessary. Low-risk inquiries (e.g., asking for general service information) may require no explicit authentication. By contrast, high-risk actions (e.g., requesting loan approval status) trigger authentication sequences based on accumulated confidence and risk scoring.

When authentication is required, the system selects the simplest effective authentication method first, escalating only if necessary. For example, a strong match of device ID, GPS location, and conversation patterns may allow automatic authentication. If uncertainty exists, the system may request a one-time passcode via SMS or email, facial recognition input, or responses to secret questions previously associated with the user.

Sessions persist across user pauses and returns. When a user resumes a session, the identity matrix and confidence state are restored, avoiding redundant authentication steps where prior context supports continuity. If session integrity cannot be assured (e.g., anomalous device changes, location jumps), reauthentication sequences may be triggered.

All authentication-related signals, decisions, and user responses are recorded in a tamper-evident audit log. This ensures that identity verifications, confidence assessments, and authentication triggers can be traced and reviewed for security analysis, compliance validation, and fraud investigation.

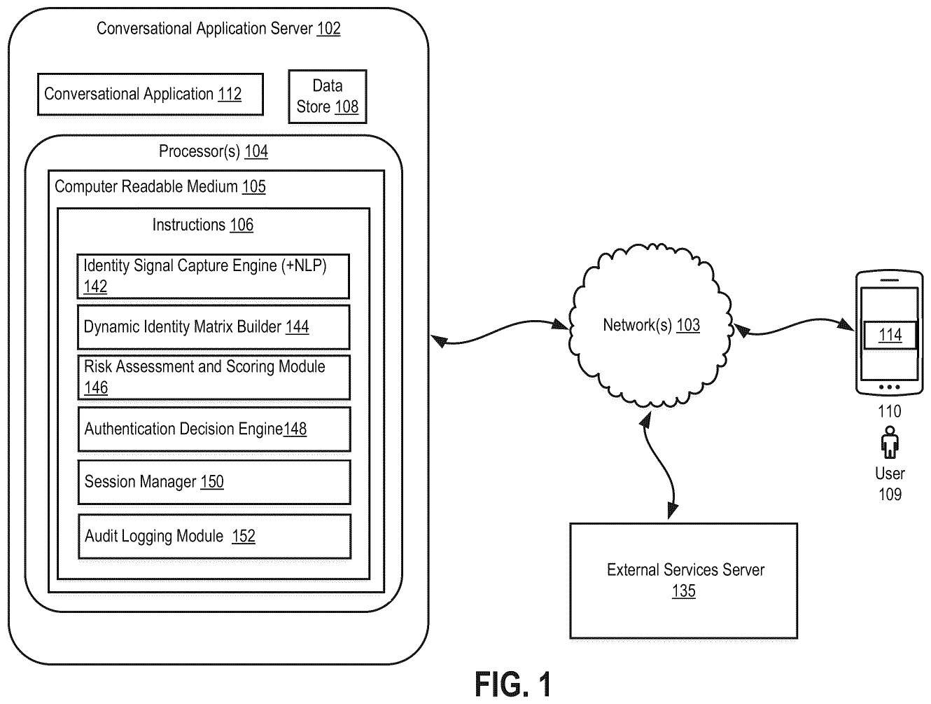

FIG. 1 illustrates exemplary system architecture for progressive user authentication based on conversational interaction. The system includes modules for identity signal capture, dynamic identity matrix construction, risk scoring, authentication decisioning, session management, and audit logging.

In the exemplary progressive user authentication system 100, a user 109 engages with a conversational application server 102 using a client computing device 110 over one or more networks 103. The interaction may begin with a natural language message or user input provided through a web-based chat interface, mobile application, or other messaging interface supported by the client device 110. Unlike traditional systems that require login credentials upfront, the progressive authentication system begins with the conversation itself. The conversational application server 102 executes a conversational application 112, using one or more processors 104 to execute instructions 106 stored in a computer-readable medium 105. The system progressively analyzes interaction data to authenticate the user without introducing unnecessary friction.

The conversational application 112 includes an interactive interface (e.g., a web-based chat interface rendered in a browser or mobile application), which facilitates real-time user engagement with the system. As the user continues the conversation, the system—through integrated modules such as the identity signal capture engine 142 and dynamic identity matrix builder 144—collects device metadata, behavioral signals, and voluntary user-provided information to construct an evolving identity profile. This profile is evaluated by a risk assessment and scoring module 146, which in turn informs the authentication decision engine 148. The server may utilize session manager 150 to maintain continuity across multiple user interactions and may store session data, identity matrices, and authentication events in a data store 108. In some embodiments, the conversational application server 102 may communicate with one or more external services servers 135 to retrieve user records, validate credentials, or trigger multi-factor authentication processes as needed.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

Client computing device 110 serves as the primary interface for user 109 to initiate and engage in a conversational session with system 100. The device may support a variety of interaction modes, including web-based chat interfaces, embedded application chat, or other messaging frameworks. In some embodiments, the client device includes a browser-based chat interface or native application that allows natural language interaction with a server-side AI assistant. The user initiates the session by providing a message or query—such as “Hi, I have a question”—without first being required to log in, allowing the system to begin passive identity analysis immediately.

The conversational interface enables the user to communicate with the assistant in natural language, while the system progressively captures identity-related signals, including device metadata, geolocation, conversational phrasing, and voluntarily provided user information. These signals are processed by the identity signal capture engine 142 and contribute to a dynamic identity matrix constructed during the session. In some embodiments, when the user initiates a high-risk request, such as accessing protected data or submitting a sensitive document, the system determines whether additional authentication is needed based on the current confidence score associated with the identity matrix. The interaction remains fluid and uninterrupted unless authentication is explicitly required.

A conversational AI assistant (AA) guides the user through interactions across the client interface. The assistant may be hosted on server 102 and operate across various modalities, such as web chat, embedded chat widgets, or integrated interfaces within partner applications. It supports real-time parsing of user inputs, intent classification, session management, and personalized flow adaptation. In some embodiments, the assistant detects ambiguity, hesitation, or elevated risk, and may initiate an authentication challenge or escalate to a human assistant (HA) depending on system policy.

The assistant may operate independently of any installed mobile application, allowing the user to access all core features—including conversation-based identity verification, authentication triggering, and workflow progression—through standard browser or embedded environments. This flexibility enables users to interact with the system from multiple devices or contexts without requiring reinstallation or manual session linking.

In some embodiments, the conversational AI assistant is provided by the conversational application 112, executed by server 102. The assistant interacts with users through natural-language conversation and dynamically adjusts its responses based on context, identity signals, and session state. It supports workflows such as user onboarding, document verification, and identity confirmation, all without requiring the user to manually enter credentials at the outset.

The AI assistant may be implemented as an integrated or third-party component operating on the server side. It processes user inputs, generates context-aware prompts, and supports identity validation through dynamic dialogue. Because the assistant operates remotely, no local installation is required on the client computing device 110.

The assistant continuously parses inputs in real time, classifies user intent, and generates targeted prompts. It may alter the phrasing, sequence, or specificity of its questions based on conversation history and detected confidence levels within the identity matrix. For example, if the user deviates from typical interaction patterns, the assistant may prompt for secondary authentication or clarification before proceeding.

In some embodiments, the assistant may also support voice-based interaction. Users may provide voice inputs via voice-enabled browsers or voice-to-text transcriptions, which are analyzed alongside typed text for identity and intent. Speech synthesis may also be supported, including distinct voice avatars for the AI assistant and any escalated human agent, enhancing clarity and user trust.

The AI assistant monitors interaction signals such as delayed responses, repeated clarification requests, or expressions of frustration. In response, it may simplify prompts, offer clarification, or propose multiple-choice selections instead of open-ended questions. These adaptive strategies improve user engagement and reduce the likelihood of drop-off or abandonment during critical stages, including authentication.

Beyond reactive adjustments, the system may use predictive models to initiate context-specific micro-workflows based on anticipated needs. For instance, if the assistant detects intent related to identity verification, it may automatically begin a document upload sequence or trigger biometric capture, depending on device capabilities and user profile.

If user responses are ambiguous, inconsistent with stored identity patterns, or suggest hesitation or confusion, the system may escalate the session to a human assistant (HA). The HA joins the session with full visibility into the user's identity matrix, chat history, and any authentication events to date. This ensures seamless continuation without requiring the user to repeat prior information.

The AI assistant may also suggest next steps or prompts for the HA to use, informed by prior session data and machine learning models optimized for task completion. For example, if the user is stuck during identity validation, the assistant might recommend: “Would you prefer to confirm your identity using a face scan or by answering a security question?” These suggestions increase the likelihood of resolution while maintaining user control and comfort.

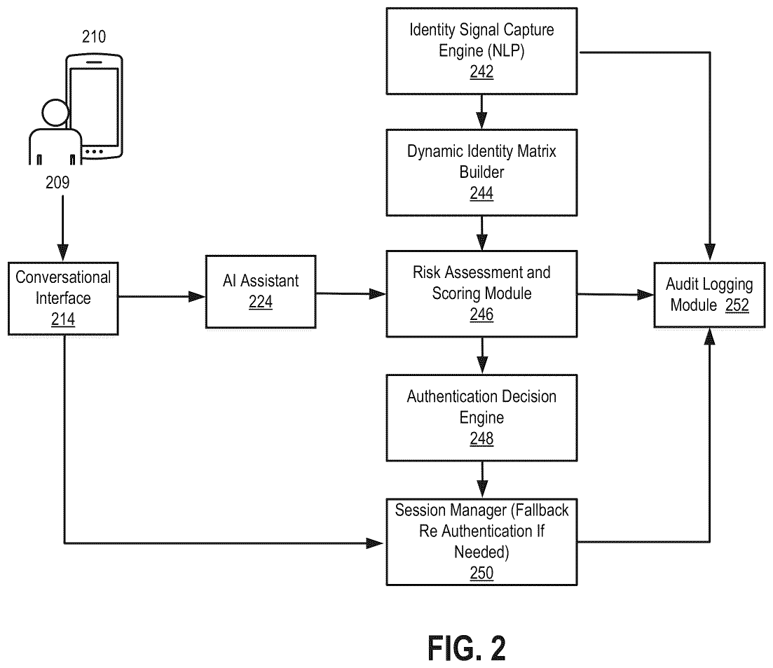

Referring now to FIG. 2, as the user 209 engages with the system through client computing device 210, the system progressively refines the user's identity profile through analysis of contextual cues, device metadata, linguistic patterns, and prior interaction history. The identity signal capture engine 242 continuously ingests these signals—including geolocation, device fingerprinting, conversational phrasing, and user-provided identity statements—and transmits them to the dynamic identity matrix builder 244, which updates the evolving identity representation in real time. When the user initiates a request involving sensitive or privileged operations—such as checking loan status, uploading identification documents, or accessing protected records—the risk assessment and scoring module 246 evaluates the current confidence score of the identity matrix. If the score meets or exceeds a predetermined threshold, the authentication decision engine 248 permits the requested action without further challenge. If the score is below the threshold or indicative of anomalous behavior (e.g., unusual device, unfamiliar phrasing, new location), the system triggers an appropriate authentication challenge, such as an OTP, biometric scan, or secret question. All signals, risk scores, and decision outcomes are recorded by the audit logging module 252 for traceability and compliance.

If the available identity signals are insufficient to authenticate the user with high confidence—such as when engagement occurs from an unrecognized device or location—the authentication decision engine 248 invokes a fallback authentication process. The challenge method may vary depending on the user's profile, authentication preferences, and device capabilities. For example, the system may transmit a one-time passcode to a verified communication channel, prompt for a secret question, or initiate biometric authentication using device 210. These fallback mechanisms are selected dynamically and may escalate depending on the level of assessed risk. Upon successful challenge completion, the session is upgraded to authenticated status, and the dynamic identity matrix builder 244 is updated to reflect the validated inputs. The session manager 250 stores authentication state and user context, enabling future sessions to resume seamlessly unless new risk indicators are detected. All fallback authentication steps, outcomes, and triggers are logged by the audit logging module 252.

In some embodiments, the system may authenticate the user automatically—without issuing an explicit challenge—when the confidence score in the identity matrix exceeds a required threshold. For example, a returning user 209 accessing the system via a known client device 210, in a familiar location and exhibiting typical language patterns, may be passively recognized by the authentication decision engine 248. The system grants access transparently, allowing the user to proceed without interruption. The session manager 250 restores the user's session, including chat history, authentication state, and any in-progress tasks. If the session had been paused or interrupted, the identity matrix stored by the dynamic identity matrix builder 244 is retrieved to reestablish context. This auto-authentication pathway improves usability in asynchronous and multi-device settings. All events—including passive authentication approvals and contributing signal factors—are logged by the audit logging module 252.

As shown in FIG. 2, user 209 initiates interaction with the system via client computing device 210 using a conversational interface 214. This interface may take the form of a browser-based chat, mobile app component, or embedded widget that allows for natural language engagement. The user's message is processed by an AI assistant 224, which coordinates session flow and identifies potential authentication-relevant content. Early in the interaction, identity signals are captured passively without requiring explicit credential input, enabling the system to begin forming a confidence-based identity profile.

These signals are processed by the identity signal capture engine 242, which applies natural language processing and metadata extraction techniques. The extracted data feeds into the dynamic identity matrix builder 244, which generates an evolving identity representation. Based on this matrix, the risk assessment and scoring module 246 computes a confidence score and passes the result to the authentication decision engine 248. If authentication is required, the session manager 250 manages fallback interactions and preserves session state across challenges or reentry. All system events—including passive signal capture, scoring decisions, and authentication actions—are logged by the audit logging module 252 to support compliance and traceability.

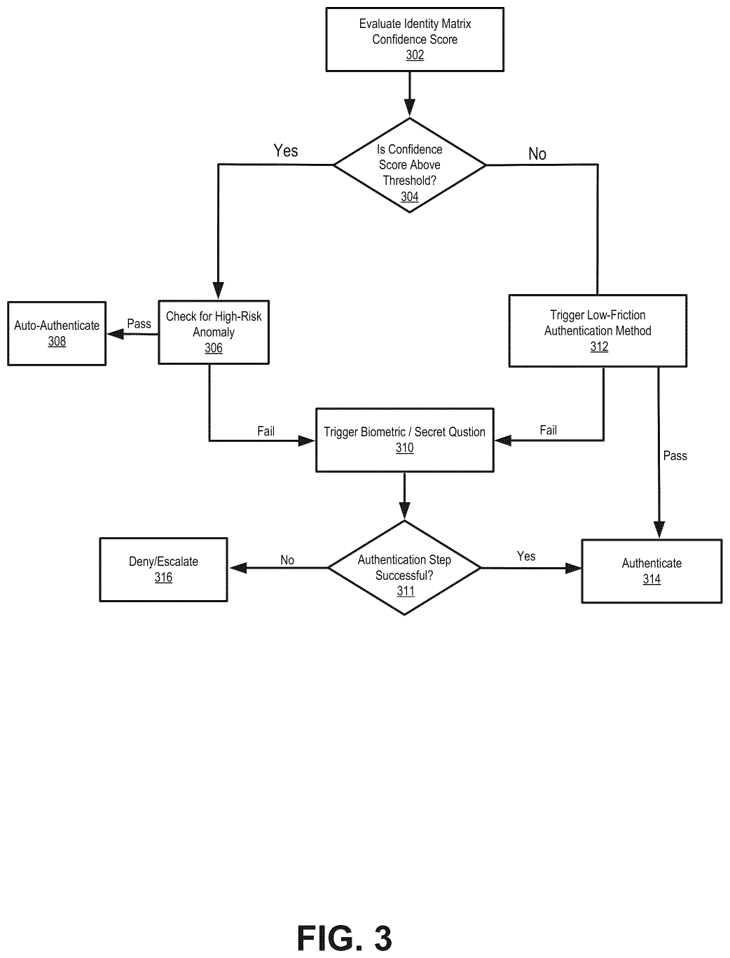

FIG. 3 illustrates a decision tree used by the progressive authentication system to dynamically determine the appropriate authentication path based on user context, system confidence, and risk evaluation. At step 302, the system evaluates the user's identity matrix confidence score, which is derived from previously captured identity signals, behavioral patterns, device metadata, and session-specific cues, as discussed above with respect to FIG. 2. The resulting confidence score is then evaluated at decision node 304 to determine whether it meets or exceeds a predefined threshold indicative of high-trust sessions.

If the score is above the threshold, the system proceeds to step 306, where it checks for the presence of any high-risk request or behavioral anomaly. Examples of high-risk conditions include requests to access sensitive financial data, modify identity records, initiate transactions, or any behavior inconsistent with the user's historical interaction patterns. If no anomaly or elevated risk is detected, the system proceeds to step 308, where the user is automatically authenticated without requiring any explicit challenge. This path represents the lowest-friction experience and relies entirely on the strength of the identity matrix and contextual risk profile. However, if the system detects a high-risk trigger at step 306, it proceeds instead to step 310, where a stronger authentication mechanism is invoked, such as biometric verification or challenge questions previously selected by the user.

If the identity confidence score is below the threshold at decision node 304, the system instead initiates step 312, which triggers a low-friction authentication method such as sending a one-time passcode (OTP) to a previously verified communication channel. If the user successfully completes this challenge, the system proceeds directly to step 314, where the user is marked authenticated and granted access to the protected workflow. If the low-friction authentication method fails (e.g., incorrect OTP, expired token, or no response), the system escalates to step 310, invoking a stronger authentication challenge.

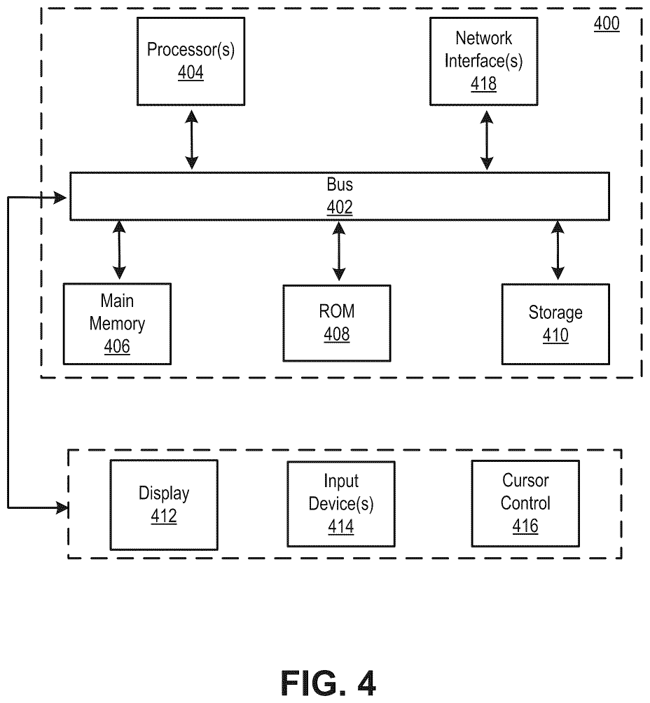

Upon reaching step 310, the system administers the selected fallback authentication method. After user interaction, the system evaluates the result at decision node 311. If the user successfully completes the biometric scan or secret question challenge, the session proceeds to step 314, where the system confirms authentication and resumes the user's workflow. If the user fails this challenge (e.g., incorrect biometric data, wrong answer, or timeout), the system proceeds to step 316, where the session is either denied access or escalated to a human assistant (HA) for manual verification. The HA may be granted access to the identity matrix, session history, and prior authentication attempts to assist in resolution. All events and transitions between these states are logged by the audit logging module 252 described in FIG. 2.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 4. Various embodiments are described in terms of this example computing module 400. After reading this description, it will become apparent to a person skilled in the relevant art how to implement the technology using other logical circuits or architectures.

FIG. 4 illustrates an example computing module 400, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 4. Various embodiments are described in terms of this example-computing module 400. After reading this description, it will become apparent to a person skilled in the relevant art how to implement the application using other computing modules or architectures.

Referring now to FIG. 4, computing module 400 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 400 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 400 might include, for example, one or more processors, controllers, control modules, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing module 400 or to communicate externally. The bus 402 may also be connected to other components such as a display 412, input devices 55, or cursor control 416 to help facilitate interaction and communications between the processor and/or other components of the computing module 400.

Computing module 400 might also include one or more memory modules, simply referred to herein as main memory 406. For example, preferably random-access memory (RAM) or other dynamic memory might be used for storing information and instructions to be executed by processor 404. Main memory 406 might also be used for storing temporary variables or other intermediate information during execution of instructions to be executed by processor 404. Computing module 400 might likewise include a read only memory (“ROM”) 408 or other static storage device 410 coupled to bus 402 for storing static information and instructions for processor 404.

Computing module 400 might also include one or more various forms of information storage devices 410, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 410 might include other similar instrumentalities for allowing computer programs or other instructions or data to be loaded into computing module 400. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 400.

Computing module 400 might also include a communications interface or network interface(s) 418. Communications or network interface(s) interface 418 might be used to allow software and data to be transferred between computing module 400 and external devices. Examples of communications interface or network interface(s) 418 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 418 might typically be carried on signals, which can be electronic, electromagnetic (which includes optical) or other signals capable of being exchanged by a given communications interface. These signals might be provided to communications interface 418 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 406, ROM 408, and storage unit interface 410. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 400 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for progressively authenticating a user during a conversational interaction, the method comprising:
receiving, via a client computing device, a natural language message from a user;
during an ongoing conversation, capturing one or more identity signals associated with the user, the identity signals comprising at least one of device metadata, geolocation data, conversational phrasing, or historical interaction patterns;
generating, based on the one or more identity signals, a confidence score indicating a likelihood that the user is an authorized user;
determining whether the confidence score exceeds a predefined threshold;
if the confidence score exceeds the threshold, evaluating whether the user request is associated with a high-risk operation or behavioral anomaly;
if no high-risk operation or anomaly is detected, authenticating the user without requiring additional input;
if a high-risk operation or anomaly is detected, prompting the user to complete a fallback authentication challenge;
if the confidence score does not exceed the threshold, initiating a low-friction authentication challenge;
if the user fails the low-friction authentication challenge, prompting the user to complete the fallback authentication challenge;
authenticating the user upon successful completion of either the low-friction authentication challenge or the fallback authentication challenge; and
recording one or more authentication events, identity signals, or challenge outcomes in an audit log.

2. The method of claim 1, wherein the identity signals further comprise time of day of the interaction, historical success or failure of prior authentication attempts, or application usage patterns associated with the client computing device.

3. The method of claim 1, wherein generating the confidence score comprises weighting each identity signal based on historical reliability, aggregating weighted signals, and normalizing the result to produce the confidence score.

4. The method of claim 1, wherein determining whether the user request is associated with a high-risk operation comprises analyzing a requested action type, prior user behavior patterns, or deviation from a previously established interaction profile.

5. The method of claim 1, wherein the low-friction authentication challenge comprises sending a one-time passcode (OTP) to a verified email address or mobile device, or requiring the user to click a secure tokenized link.

6. The method of claim 1, wherein the fallback authentication challenge comprises prompting the user for biometric input, or prompting the user to answer a previously selected security question.

7. The method of claim 1, wherein authenticating the user without requiring additional input comprises determining that the user has returned from a previously authenticated session, verifying that the client computing device matches a known trusted device, and confirming that the current location is within a trusted region.

8. The method of claim 1, further comprising:
updating the identity matrix associated with the user based on successful or failed authentication attempts; and
adjusting the weighting of one or more identity signals in future confidence score computations.

9. The method of claim 1, wherein recording authentication events in an audit log comprises generating a tamper-evident log entry including the authentication path selected, a timestamp, and an anonymized identifier for the user session.

10. The method of claim 1, further comprising upon failure of the fallback authentication challenge, escalating the session to a human assistant, and transmitting the user's interaction history, confidence score, and prior challenge results to the human assistant for manual verification.

11. The method of claim 1, wherein capturing the one or more identity signals comprises initiating identity signal collection upon receipt of the user's initial natural language message and prior to presenting any explicit authentication challenge.

12. A computer-implemented system for progressively authenticating a user during a conversational interaction, the system comprising:
a client computing device configured to:
transmit natural language messages from a user; and
receive authentication prompts and responses;
a server system comprising:
an identity signal capture module configured to collect one or more identity signals associated with the user during the conversational interaction, the identity signals comprising at least one of device metadata, geolocation data, conversational patterns, or historical interaction data;
a confidence scoring module configured to:
generate a confidence score based on the one or more identity signals; and
determine whether the confidence score exceeds a predefined threshold;
a risk assessment module configured to evaluate whether a user request is associated with a high-risk operation or behavioral anomaly;
an authentication decision engine configured to:
if the confidence score exceeds the threshold and no high-risk operation or anomaly is detected, authenticate the user without requiring additional input;
if the confidence score exceeds the threshold and a high-risk operation or anomaly is detected, prompt the user to complete a fallback authentication challenge;
if the confidence score does not exceed the threshold, initiate a low-friction authentication challenge;
if the user fails the low-friction authentication challenge, prompt the user to complete the fallback authentication challenge; and
authenticate the user upon successful completion of either the low-friction authentication challenge or the fallback authentication challenge; and
an audit logging module configured to record authentication events, identity signals, and challenge outcomes for compliance and security auditing.

13. The system of claim 12, wherein the identity signals further comprise time of day of the interaction, historical success or failure of prior authentication attempts, or application usage patterns associated with the client computing device.

14. The system of claim 12, wherein the confidence scoring module is further configured to assign weights to each identity signal based on historical reliability, aggregate the weighted signals, and normalize the result to produce the confidence score.

15. The system of claim 12, wherein the risk assessment module is further configured to analyze a requested action type, prior user behavior patterns, or deviation from a previously established interaction profile.

16. The system of claim 12, wherein the low-friction authentication challenge comprises sending a one-time passcode (OTP) to a verified communication channel, or requiring the user to click a secure tokenized link.

17. The system of claim 12, wherein the fallback authentication challenge comprises prompting the user for biometric input, or prompting the user to answer a previously selected security question.

18. The system of claim 12, wherein authenticating the user without requiring additional input comprises determining that the user has returned from a previously authenticated session, verifying that the client computing device matches a known trusted device, and confirming that the current location is within a trusted region.

19. The system of claim 12, further comprising:
updating the identity matrix associated with the user based on successful or failed authentication attempts; and
adjusting the weighting of one or more identity signals in future confidence score computations.

20. The system of claim 12, wherein the audit logging module is further configured to generate a tamper-evident log entry including the authentication path selected, a timestamp, and an anonymized identifier for the user session.

21. The system of claim 12, further comprising:
upon failure of the fallback authentication challenge;
escalating the session to a human assistant; and
transmitting the user's interaction history, confidence score, and prior challenge results to the human assistant for manual verification.
